(19) United States
(12) Patent Application Publication
(10) Pub. No.: US 2018/0153300 A1
(43) Pub. Date: Jun. 7, 2018

(54) IRONING BOARD LEG LOCK

(71) Applicant: Whitmor, Inc., Southaven, MS (US)

(72) Inventors: Steve Westcott, Memphis, TN (US); Sandy Felsenthal, Memphis, TN (US)

(21) Appl. No.: 15/372,006

(22) Filed: Dec. 7, 2016

(51) Int. Cl. A47B 3/08; F16B 2/22; F16B 2/20; F16B 7/04; A47B 3/02; A47B 13/00; D06F 81/02

(52) U.S. Cl. CPC A47B 3/0809; F16B 2/22; F16B 2/205; F16B 7/0433; A47B 2003/025; A47B 13/003; D06F 81/02; A47B 2003/0821; A47B 3/02

(57) ABSTRACT

An ironing board locking device for retaining and selectively securing a leg of an ironing board is provided. The device can include a leg locking member for securing a collapsed ironing board leg and a base attachment member for attaching the device to the base or frame of an ironing board. The leg locking member can include a pair of outwardly and oppositely extending retaining arms configured to flex outwardly in order to receive and engage the ironing board leg. The base attachment member can include two oppositely extending arms, each with a connecting component for connecting the device to both edges of the ironing board base. The base attachment member can also have bending and resilient properties to allow the base attachment member to be flex around and snap onto the ironing board base.

### CROSS-REFERENCE TO RELATED APPLICATIONS

None.

### FIELD OF THE INVENTION

The present invention is directed toward leg locking devices for use with ironing boards and other structures with collapsible legs.

### BACKGROUND OF THE INVENTION

Standing ironing boards and collapsible ironing boards are generally well known in the art. Such ironing boards normally have an ironing board table supported by a base or frame and two or more legs attached to the table and/or base. For example, one style of ironing board includes an ironing board with pivoting scissor-style legs that can move between an extended position and a collapsed position where the legs rest against the base of the ironing board. Another style of ironing board includes two collapsible legs at one end of the frame and another third collapsible leg located at an intermediate point along the length of the frame. All three legs are connected together and move in the same direction when they are collapsed against the base of the ironing board for storage.

In order to secure the legs in a collapsed position, each of these ironing boards commonly includes a locking mechanism. The locking mechanism can be in the form of a clip or latch positioned on or within one of the legs and configured to prevent the legs from moving via the supporting bars connecting the legs together. The locking mechanism can also be in the form of a clip extending from the ironing board and configured to receive and hold one of the legs. These types of locking clips can wear over time, and eventually become ineffective at retaining the collapsible legs, can break, or can become dislodged from the ironing board frame. Such a clip is additionally only designed for one particular style of ironing board.

Accordingly, a need exists for a locking mechanism for an ironing board structure that is durable, selectively removable from and reattachable to the ironing board, and configured for use with many different styles of ironing boards.

### SUMMARY OF THE INVENTION

The present invention is directed generally to a locking mechanism for a collapsible leg, and more particularly, to a leg locking device for securing a collapsible ironing board leg to the base of the ironing board. The leg locking device can be configured to be removably attached to the underside of an ironing board and can further be configured to selectively retain a leg of the ironing board. The device can include a base attachment member and a leg locking member extending generally perpendicularly away from the base attachment member. The leg locking member can have two extending arms forming a partially enclosed opening that can be configured for receiving and retaining the ironing board leg. Each arm can include an outwardly flared end that can facilitate guiding the ironing board leg into the partially enclosed opening. In addition, the opening can be configured to be slightly smaller than the cross-section of the ironing board leg so that the arms remain tightly against the ironing board leg to hold and secure it into position.

The base attachment member can include two oppositely extending arms, each having an attachment or connecting component along its free end. The first arm can include a first connecting component configured with a curved extension section and a curled edge that creates a circular opening below the arm. The second arm can include a second connecting component configured with a downward flange and inward turned edge that creates a small rectangular groove. The first connecting component can be configured to fit around and secure to the edge of an ironing board base having a rolled lip while the second connecting component can be configured to fit over and secure to the straight rectangular edge of the ironing board base.

In order to secure the device to the ironing board, the first connecting component of the base attachment member can be positioned onto the rolled lip edge of the ironing board base and the device can be bent and/or flexed until the second connecting component snaps over the straight rectangular edge of the ironing board base. The leg locking device can be configured with flexible and resilient characteristics so that it can be flexed onto the ends of the ironing board base and subsequently remains secured to the ironing board base until selectively removed. This can reduce the likelihood that the device will break or wear over time and allow the device to be removed and reconnected to the ironing board. It can also allow the device to be used with different styles of ironing boards more effectively.

Other aspects and advantages of the present invention will be apparent from the following detailed description of the preferred embodiments and the accompanying drawings figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a bottom perspective view of an ironing board having a leg locking device in accordance with one embodiment of the present invention;

FIG. 2 is a perspective view of a leg locking device in accordance with one embodiment of the present invention;

FIG. 3 is a side elevation view of the leg locking device of FIG. 2;

FIG. 4 is a front elevation view of the leg locking device of FIG. 2;

FIG. 5 is a top plan view of the leg locking device of FIG. 2;

FIG. 6 is a partial perspective view of a leg locking device attached to an ironing board base plate and retaining an ironing board leg in accordance with one embodiment of the present invention; and

FIG. 7 is a side elevation section view of the leg locking device and ironing board of FIG. 6 illustrating the leg locking device attached to the ironing board base plate in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

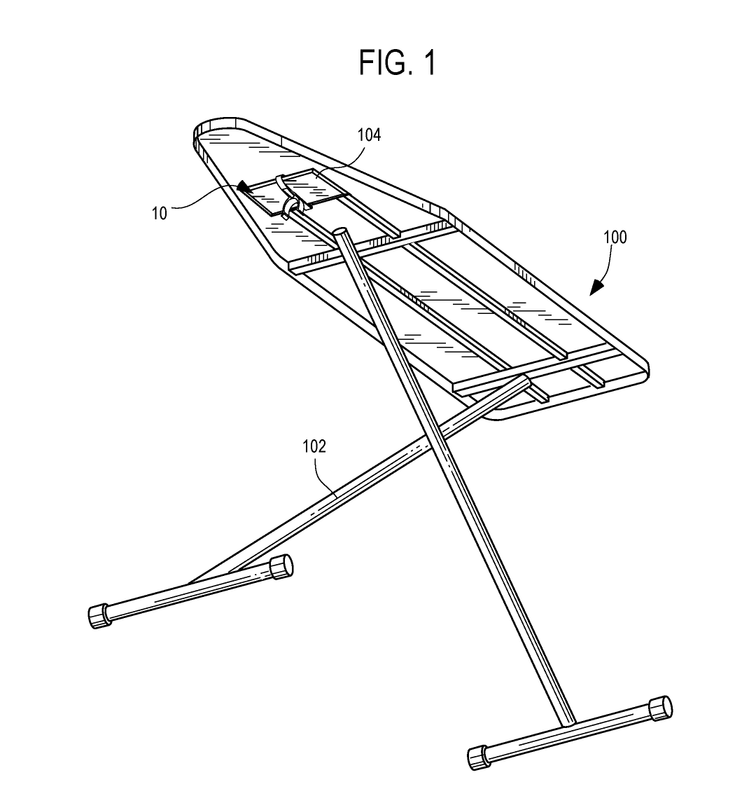

The present invention is directed generally to a leg locking device 10 configured for use in connection with an ironing board 100 as shown in FIG. 1. Leg locking device 10 can be used to hold and retain an ironing board leg 102 when ironing board 100 is in a collapsed position and leg 102 is positioned against a base plate 104 of the frame ironing board 100. As shown in FIG. 1, leg locking device 10 can be removably connected to base plate 104 on the underside of the frame of ironing board 100. When ironing board 100 is collapsed, leg 102 of ironing board 100 can be removably connected to leg locking device 10 in order to hold it adjacent to ironing board 100 as described in greater detail below.

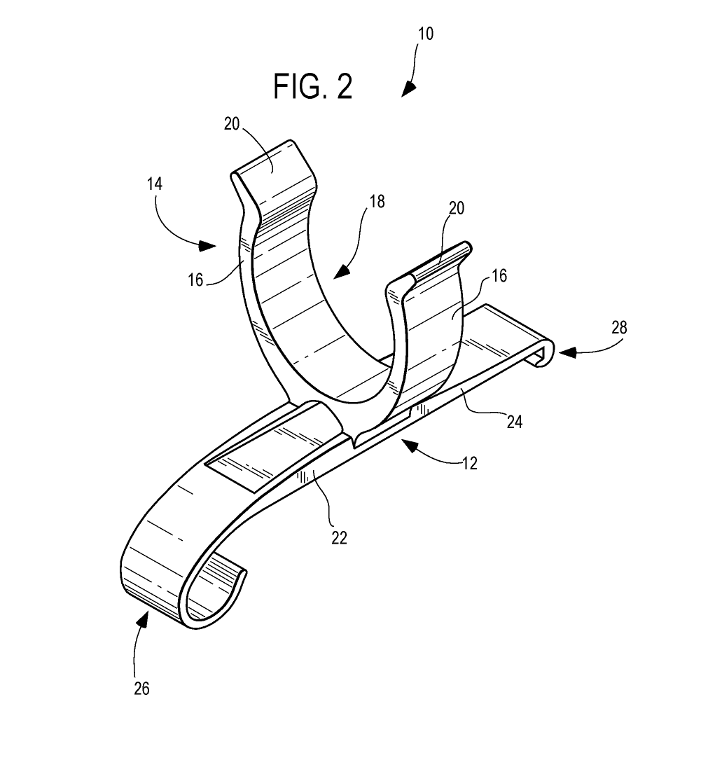

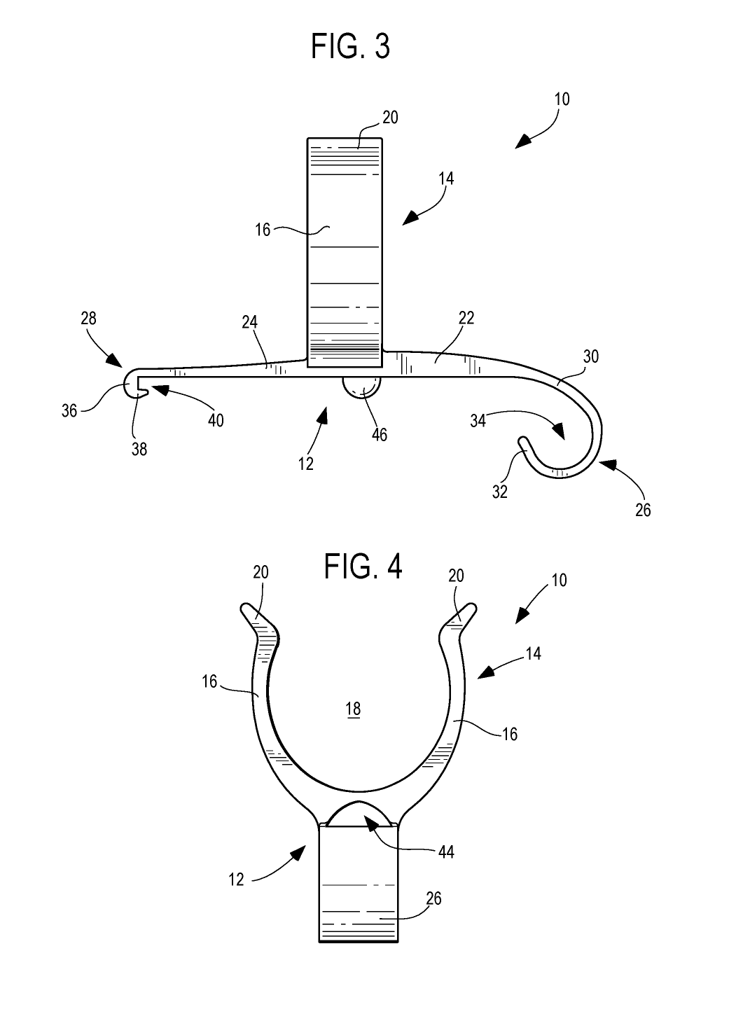

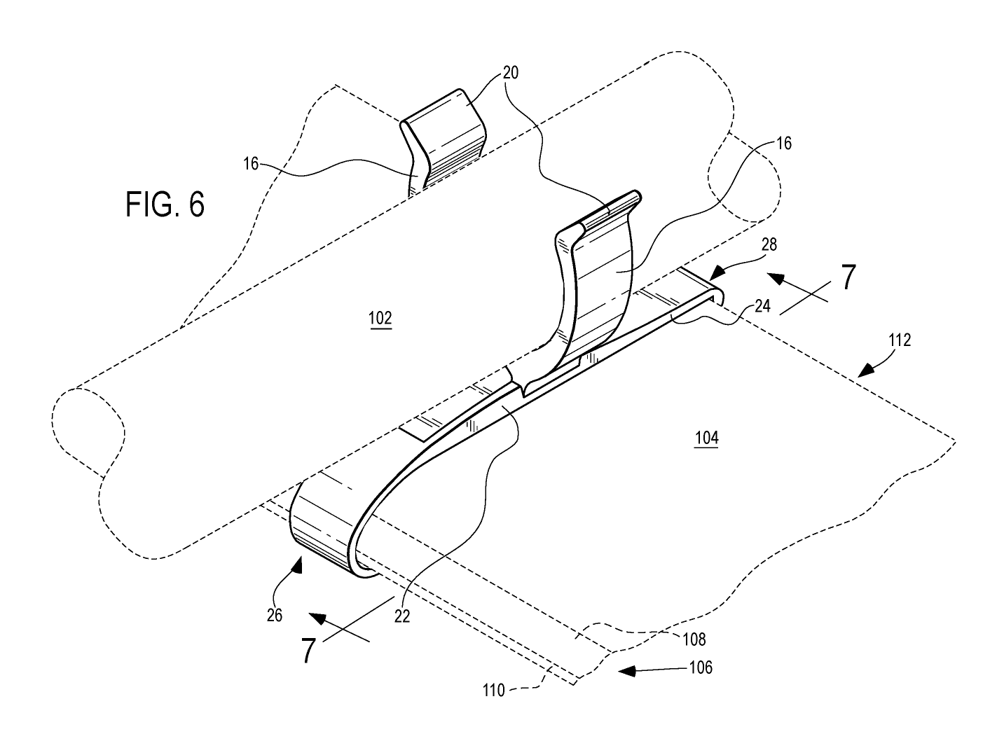

Turning to FIGS. 2-5, device 10 can include a base attachment member 12 and a leg locking member 14. Base attachment member 12 can be configured for selectively and/or removably connecting device 10 to base plate 104 of ironing board 100 as described in greater detail below. Leg locking member 14 can be configured for selectively retaining and locking leg 102 of ironing board 100 as also described in greater detail below. As best shown in FIGS. 2 and 4, leg locking member 14 can include a pair of outwardly extending arms 16 having a generally rounded or curved shape that form a partially enclosed slot or opening 18 extending therethrough. As shown, arms 16 extend only partially around opening 18 so that opening 18 remains only partially enclosed and accessible from the terminal ends of arms 16. As illustrated in FIG. 3 (and FIG. 6), opening 18 can be configured to generally conform to the size and cross-sectional shape of ironing board leg 102 so that leg 102 can be received and retained by arms 16. According to one embodiment of the present invention, arms 16 can have a curved shape with a convex exterior in order to define opening 18 with a generally circular cross-sectional shape that conforms to the typical shape of an ironing board leg 102. Each arm 16 can additionally include an outwardly flared end 20 that can facilitate guiding leg 102 into opening 18 and flexing arms 16 apart in order to remove leg 102 from device 10. Arms 16 can additionally be configured so that the diameter of opening 18 is slightly smaller than the general diameter of ironing board leg 102. In such a configuration, when ironing board leg 102 is pressed through outwardly flared ends 20 and into opening 18, arms 16 press onto the sides of ironing board leg 102 to hold it in place.

As further shown in FIGS. 2-5, base attachment member 12 can extend generally transverse to locking member 14 and can include a first arm 22 and a second arm 24. As best shown in FIG. 2, positioned at the free or terminal end of first arm 22 can be a first connector component 26 and positioned at the free or terminal end of second arm 24 can be a second connector component 28. First and second connector components 26 and 28 can be configured to attach to the terminal edges of ironing board base plate 104 in order to secure device 10 to ironing board 100 as described in greater detail below.

As best shown in FIG. 3, first connector 26 can include a downwardly curved extension section 30 and an inwardly curled terminal end 32. The configuration of extension section 30 and curled terminal end 32 can defined a circular- or oval-shaped slot 34, which can allow first connector 26 to receive and retain a first terminal edge 106 of ironing board base plate 104 (as best illustrated in FIG. 6). As also shown in FIG. 3, second connector 28 can include a downwardly extending flange 36 having an inward-turned edge 38. Flange 36 and edge 38 collectively create a groove 40 between second arm 24 and connector 28. According to the embodiment illustrated in FIG. 3, first connector 26 is configured to attach to a rounded or rolled terminal edge and second connector 28 is configured to attach to a flat or straight terminal edge. As a result, curved extension section 30 and curled terminal end 32 of first connector 26 are configured to create a larger curved opening 34 to fit around the curvature of the rolled edge while flange 36 and edge 34 are configured to create a smaller rectangular groove 40 to receive rectangular end of the straight edge. However, it is recognized that first and second connectors 26 and 28 can be adapted to attach to various types of edges depending on the style and configuration of ironing board 100 and base plate 104 in alternative embodiments of the present invention.

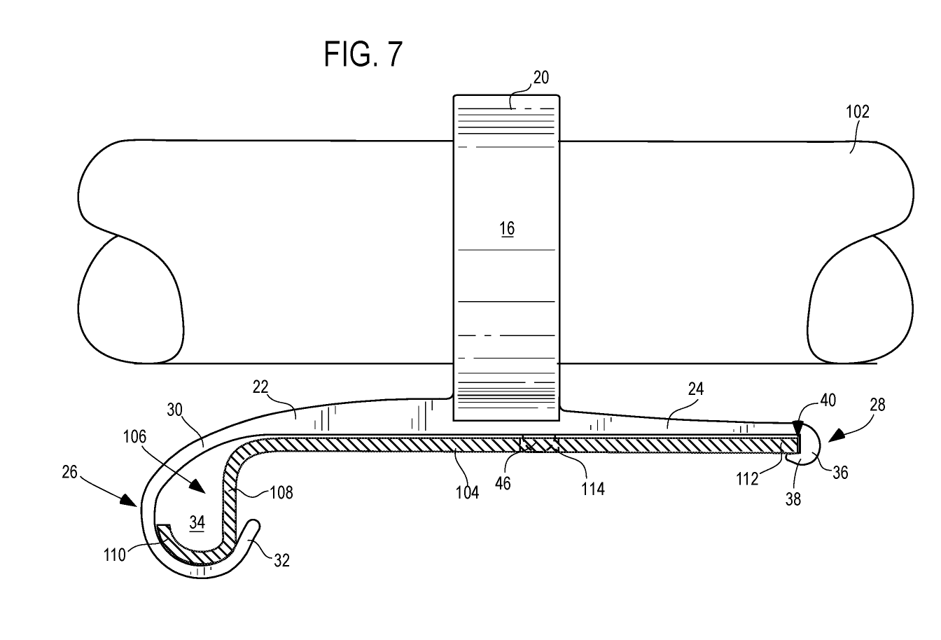

Turning to FIGS. 6 and 7, device 10 is illustrated in connection with ironing board 100, leg 102 and base plate member 104. As shown in FIG. 6, first terminal edge 106 of base plate 104 can include a downwardly depending flange 108 and rounded, outwardly-curved lip 110. As best illustrated in FIG. 7, the curved configuration of extension section 30 can allow first connector 26 to fit around flange 108 and under lip 110 so that lip 110 and part of flange 108 can be retained in slot or opening 34 of first connector member 26. As also shown in FIG. 6, base plate 104 can have a second terminal edge 112 on the end opposite of first terminal edge 106. Second terminal edge 112 can be configured as a generally orthogonal and flattened edge as illustrated in FIGS. 6 and 7. As best shown in FIG. 7, second connector 28 can be positioned around second edge 112 so that second edge 112 is retained within groove 40. As shown, second edge 112 can be seated on inward turned edge 38 of second connector 28 in order to secure second terminal edge 112 at least partially within groove 40.

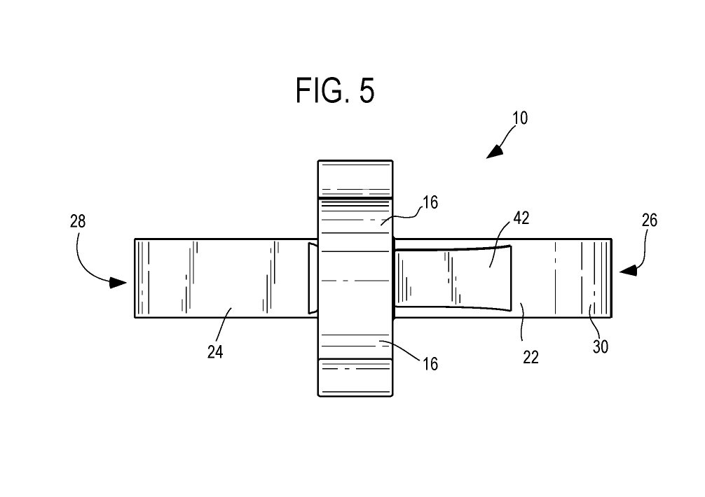

Turning back to FIGS. 4 and 5, device 10 can include a channel 42 extending along the top of base attachment member 12, under leg locking member 14, and partially along the length of first and second arms 22 and 24. As shown, channel 42 can extend between base attachment member 12 and leg locking member 14 and create an opening 44 extending therebetween. Channel 42 can also provide for a reduced thickness of first and second arms 22 and 24 of base attachment member 12. Collectively, channel 42 and opening 44 can allow first and second arms 22 and 24 to flex or slightly bend in a resilient manner in order to assist in attaching first connecting member 26 and second connecting member 28 to base plate 104 of ironing board 100 as described below. Similarly, opening 44 can allow first and second arms 16 and 18 of leg locking member 14 to resiliently flex when leg 102 of ironing board is received or removed froth device 10.

In addition to channel 42 and opening 44, the flexibility and resilient characteristics of device 10 can be at least partially provided by sidewall thicknesses of first and second base member attachment arms 22 and 24. As best shown in FIG. 3, first arm 22 can have a first sidewall thickness greater a second sidewall thickness of second arm 24. In addition, channel 42 can extend along first arm 22 a greater distance than channel 42 extends along second arm 24 (as best illustrated in FIG. 5). Together, the increased perimeter sidewall thickness of first arm 22 and the increased length of channel 42 along first arm 22 (which reduces the interior thickness of first arm 22) can increase the bending and flexibility of first arm 22 while retaining its resilient characteristics so that base attachment member 12 returns to is original position. This configuration can allow first arm 22 and first connector 26 to be significantly flexed when attaching device 10 to ironing board 100 as described below.

As illustrated in FIGS. 3 and 7, base attachment member 12 can include a locking button 46 that can help secure device 10 in place relative to ironing board base plate 104 when device 10 is attached thereto. As shown in FIG. 3, locking button 46 can be configured as a downward projecting protrusion extending from first or second arms 22 or 24. FIG. 3 illustrates button 46 positioned near the center of base attachment member 12; however, button 46 can just as suitably be positioned at any intermediate position between first and second connector ends 26 and 28. As shown in FIG. 7, button 46 on base attachment member 12 can correspond and conform to a receiving opening 114 defined into base plate 104 of ironing board 100. Opening 114 can be slightly larger than button 46 to allow button 46 to be inserted at least partially therethrough. Similar to button 46, opening 114 can be positioned anywhere along the length of base plate 104; however, opening 114 should be positioned along base plate 104, and button 46 should be positioned along base attachment member 12, so that both button 46 and opening 114 are properly aligned when first and second connector ends 26 and 28 of base attachment member 12 are attached to first and second ends 106 and 112 of base plate 104.

Button 46 and opening 114 can function as a guide to allow device 10 to be properly aligned with collapsible leg 102 when device 10 has been attached to base plate 104 of ironing board 100. Button 46 and opening 114 can also prevent device 10 from shifting laterally once attached to base plate 104 due to the connecting fit when button 46 is positioned within opening 114.

As illustrated in the figures, device 10 can be configured for attachment to a base plate 104 of an ironing board 100. As best shown in FIG. 1, base plate 104 can be attached to the frame of ironing board 100 on the underside thereof. According to one embodiment of the present invention, device 10 can be attached by first placing first connector 26 around the rounded first terminal edge 106 of base plate 104. The rounded configuration of connector 26 can allow curled terminal end 32 to be placed underneath lip 110 of base plate first terminal edge 106 and partially behind flange 108. Device 10 can then be rotated over the flat side of base plate 104 until second connector 28 is positioned adjacent to base plate second terminal edge 112. Second attachment arm 22 can then be pressed downward to flex device 10 (and mainly base attachment member 12) so that second connector 28 bends upward and inward-turned edge 38 extends beyond base member edge 112.

The resilient nature of second attachment arm 22 and base attachment member 12 can allow second connector 28 to snap onto second terminal edge 112 of base plate 104. Once device 10 is secured to base plate 104, collapsible leg 102 of ironing board 100 can be inserted into opening 20 of leg locking member 14 in order to secure the leg 102 in a collapsed position. Device 10 can also be selectively removed from base plate 104 by pulling curled terminal 32 of first connector 26 until it is removed from first terminal edge 106 of base plate 104 and then sliding second connector 28 away from second edge 112 of base plate 104.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A leg locking device for selectively retaining a collapsible leg of an ironing board in a collapsed position, said device comprising:
a leg locking member comprising two outwardly extending arms, wherein said two outwardly extending arms form a partially enclosed opening for receiving said collapsible leg of said ironing board; and
a base attachment member connected to said leg locking member, said base attachment member comprising:
a first atm extending transversely away from said leg locking member in a first direction;
a second arm extending transversely away from said leg locking member in a second direction, said second direction generally opposite said first direction;
a first connector component positioned at a terminal end of said first arm; and
a second connector component positioned at a terminal end of said second arm;
wherein said base attachment member is configured to be selectively attached to a base plate of said ironing board in general alignment with an axis of rotation of said collapsible leg, wherein said first connector component is configured to engage a first terminal edge of said base plate and said second connector component is configured to engage a second terminal edge of said base plate.

2. The device of claim 1, wherein said two outwardly extending arms of said leg locking member have a curved shape defining a circular cross-sectional shape of said opening.

3. The device of claim 1, wherein said two outwardly extending arms of said leg locking member each have an outwardly flared terminal end.

4. The device of claim 1, wherein said first connector component comprises a curved extension section extending from said terminal end of said first arm and a curled terminal end, wherein said curved extension section and said curled terminal end define a first connector component partially enclosed opening.

5. The device of claim 4, wherein said first connector component partially enclosed opening has a generally circular cross-sectional shape.

6. The device of claim 5, wherein said first connector component is configured to at least partially receive within said first connector component partially enclosed opening an outwardly curved lip and a downwardly depending flange of said first terminal edge of said base plate when said device is attached to said base plate.

7. The device of claim 6, wherein said curled terminal end of said of said first connector component engages at least part of said downwardly depending flange of said base plate first terminal edge when said device is attached to said base plate.

8. The device of claim 1, wherein said second connector component comprises a downward flange extending generally perpendicularly from said second arm and an inward-turned terminal edge extending from said downward flange.

9. The device of claim 8, wherein said downward flange and said inward-turned terminal edge of said second connector component define a groove below said second arm.

10. The device of claim 9, wherein said groove is configured for at least partially receiving said second terminal edge of said ironing board base plate when said device is attached to said base plate.

11. The device of claim 1 further comprising a channel defined at least partially longitudinally along said first and said second arms of said base attachment member.

12. The device of claim 11, wherein said channel creates a reduced thickness of at least a portion of said first and said second arms of said base attachment member.

13. The device of claim 11, wherein said channel extends a first distance along said first atm that is greater than a second distance along said second arm.

14. The device of claim 11, wherein said channel extends under said leg locking member and forms a channel opening extending between said base attachment member and said leg locking member.

15. The device of claim 14, wherein said channel and said channel opening increase a resilient flexible characteristic of said first and said second arms of said base attachment member.

16. A leg locking device for configured use with an ironing board having a base plate positioned along an underside of said ironing board and a collapsible leg rotatably connected to said underside of said ironing board, wherein said base plate includes a first terminal edge having a downward depending flange and an outward-curled lip extending therefrom, said leg locking device comprising:
a leg locking member configured for selectively securing said collapsible leg in a collapsed position adjacent to said base plate of said ironing board; and
a base attachment member comprising a first arm extending away from said leg locking member and having a first connector configured for attaching to said first terminal edge of said base plate and a second arm extending away from said leg locking member of said base plate in a direction opposite of said first arm, said second arm having a second connector configured for attaching to said second terminal edge of said base plate.

17. The leg locking device of claim 16, wherein said first connector comprises a curved extension section extending from a terminal end of said first arm and a curled terminal end connected to said curved extension section, wherein said curved extension section and said curled terminal end define a partially enclosed opening configured to at least partially receive said outward-curled lip and downward depending flange of said base plate first terminal edge.

18. The leg locking device of claim 17, wherein said second connector comprises a downward flange extending from a terminal end of said second arm and extending generally perpendicular to said second arm and an inward-turned terminal edge extending from said downward flange, wherein said downward flange and said inward-turned terminal edge define a groove below said second arm configured to at least partially receive said second terminal edge of said base plate.

19. The leg locking device of claim 18, wherein said base attachment member further comprises a channel defined at least partially into said first and said second arms in a longitudinal direction, wherein said channel at least partially reduces a first thickness of said first arm and a second thickness of said second arm to increase a resilient flexible characteristic of said base attachment member.

20. The leg locking device of claim 18, wherein said channel extends below said leg locking member and defines an opening between said leg locking member and said base attachment member.
